(19) United States
(12) Patent Application Publication
(10) Pub. No.: US 2009/0035660 A1
(43) Pub. Date: Feb. 5, 2009

(54) NONAQUEOUS ELECTROLYTE SECONDARY BATTERY

(75) Inventors: Toyoki FUJIHARA, Moriguchi-shi (JP); Keisuke MINAMI, Moriguchi-shi (JP); Naoya NAKANISHI, Moriguchi-shi (JP); Toshiyuki NOHMA, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/181,696

(22) Filed: Jul. 29, 2008

(30) Foreign Application Priority Data
Jul. 31, 2007 (JP) 2007-198434

(51) Int. Cl. H01M 4/52; H01M 4/40; H01M 4/58; H01M 4/50

(52) U.S. Cl. 429/223; 429/231.95; 429/231.8; 429/224

(57) ABSTRACT

A nonaqueous electrolyte secondary battery of the invention uses as positive electrode active material a lithium transition metal compound expressed by Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1) into/from which lithium ions are insertable/separable, and uses a negative electrode that has initial charge/discharge efficiency of 80% or over but no more than 90%. Thanks to these, the battery can be charged or discharged at large current of 50 A or higher and can have a superior output characteristics and input/output characteristics.

### TECHNICAL FIELD

The present invention relates to a nonaqueous electrolyte secondary battery. More particularly it relates to a nonaqueous electrolyte secondary battery that uses a particular positive electrode active material, and as the negative electrode active material uses carbon with initial charge/discharge efficiency of 80 to 90%; that has excellent load characteristics and input/output characteristics whereby even if charge/discharge is performed under large current equal to or larger than 50 A, increase of the IV resistance value at low depths of discharge is curbed; and that hence is optimal for electric vehicles (EVs), hybrid electric vehicles (HEVs) and the like.

### BACKGROUND ART

Against the backdrop of the rise of environmental protection movements, regulation of emissions of carbon dioxide and so on is being strengthened and the automobile industry is vigorously pursuing development not only of automobiles using fossil fuels such as gasoline, diesel oil and natural gas, but also of EVs and HEVs. In addition, the steep soaring of prices of fossil fuels over recent years has acted as a following wind that has propelled such development. And in the field of batteries for EVs and HEVs, attention has focused on nonaqueous electrolyte secondary batteries, which have high energy density compared to other batteries and of which the typical representative is the lithium ion secondary battery. These nonaqueous electrolyte secondary batteries now constitute a large and growing share in this field.

The concrete structure of such a nonaqueous electrolyte secondary battery 10 used for EVs, HEVs and the like will now be described using FIGS. 3 to 7. FIG. 3 is a perspective view of a cylindrical nonaqueous electrolyte secondary battery. FIG. 4 is an exploded perspective view of the electrode roll in a cylindrical nonaqueous electrolyte secondary battery. FIG. 5 is a perspective view of a collector plate used in a cylindrical nonaqueous electrolyte secondary battery. FIG. 6 is a partial perspective view showing the state before the collector plate is pushed against the electrode roll. Further, FIG. 7 is a partial front view showing the state where the collector plate is pushed against the electrode roll and irradiated with a laser beam.

This nonaqueous electrolyte secondary battery 10 is so structured as to have a cylindrical battery outer can 13 constituted of a cylinder 11 with lids 12 fixed by soldering to both ends thereof, as shown in FIG. 3; and, housed in the interior of the battery outer can 13, an electrode roll 20 such as shown in FIG. 4. On the lids 12 there are mounted a pair of electrode terminal mechanisms 14, one for positive and the other for negative. The electrode roll 20 and the electrode terminal mechanisms 14 are connected inside the battery outer can 13, so that the electric power generated by the electrode roll 20 can be brought out to the exterior through the pair of electrode terminal mechanisms 14. Also, a pressure-operated gas vent valve 15 is installed on each lid 12.

The electrode roll 20 is so structured as to have a positive electrode 21 and a negative electrode 22, both strip-form, which are rolled into a spiral form with strip-form separators 23 interposed therebetween. The positive electrode 21 has positive electrode active material compound layers 21₂ that are formed by coating positive electrode compound slurry onto both sides of a strip-form substrate 21₁ constituted of aluminum foil, and the negative electrode 22 has negative electrode active material compound layers 22₂ that are formed by coating negative electrode compound slurry containing carbon material onto both sides of a strip-form substrate 22₁ constituted of aluminum foil. Also, the separators 23 are impregnated with nonaqueous electrolyte. Further, in order to assure the battery output characteristics, the electrode plates are designed to be thin and the areas of the opposed surfaces of the positive and negative electrodes to be large.

On the positive electrode 21, uncoated portions are formed parallel to the negative electrode active material compound layer 21₂ coated portions, and these uncoated portions project beyond the edge of the separator 23 and constitute a positive electrode substrate edge portion 21₃. Likewise on the negative electrode 22, uncoated portions are formed parallel to the negative electrode active material compound layer 22₂ coated portions, and these uncoated portions project beyond the edge of the separator 23 and constitute a negative electrode substrate edge portion 22₃.

At both ends of the electrode roll 20 there is installed a collector plate 30, and these collector plates 30 are attached to the positive electrode substrate edge portion 21₃ and negative electrode substrate edge portion 22₃ by laser welding or electron beam welding. An end of a lead part 31 that is installed projecting from the edge of each collector plate 30 is connected to the electrode terminal mechanism 14.

As FIGS. 4 and 5 show, the collector plates 30 have a round plate-form body 32, and multiple radially-extending arc-form protrusions 33 are integrally molded on such plate-form body 32, protruding toward the electrode roll 20. Further, the collector plates 30 are pushed in the direction of the positive electrode substrate edge portion 21₃ or negative electrode substrate edge portion 22₃ as indicated by arrow P in FIG. 6, and are welded by irradiation with a laser beam (or electron beam) as indicated by the thick arrow in FIG. 7. Such welding is carried out via successive spot welds, with the laser beam being made to move in the longitudinal direction of the arc-form protrusions 33; the bottom portions of the arc-form protrusions 33 are welded to the positive electrode substrate edge portion 21₃ or negative electrode substrate edge portion 22₃ at the weld portions 34. Thus, collection is effected by the positive electrode 21 and negative electrode 22 each being electrically connected to a separate collector plate 30.

As the positive electrode active material compound for such nonaqueous electrolyte secondary battery, use is made of a lithium transition metal composite oxide into which lithium ions can be reversibly intercalated and deintercalated and which is expressed in symbols as LiₓMO₂ (where M represents at least one out of Co, Ni and Mn), that is, LiCoO₂, LiNiO₂, LiNi_{y}CO_{1-y}O₂ (y=0.01 to 0.99), LiMnO₂, LiMn₂O₄, LiCoₓMn_{y}Ni_{z}O₂ (x+y+z=1), or LiFePO₄, etc., either singly or in a mixture of two or more thereof.

Also, a substance with carbon as its major constituent, such as natural graphite, artificial graphite, carbon black, coke, vitreous carbon, carbon fiber, or any of these fired, or multiple of these mixed, is used as the negative electrode active material.

However, although nonaqueous electrolyte secondary batteries such as described above, which are lightweight and give high energy density output, have come into use as batteries for EVs and HEVs, such vehicles are now being required to provide environmental responses and also to achieve higher levels of the driving performance that is the basic performance of automobiles. In order to achieve such higher levels of driving performance, not only must the battery capacity be made large so as to enable long-distance travel of the automobile, but also the battery output must be made large—which is to say, the fast discharge characteristics must be improved—since it exerts large influences on the automobile's acceleration performance and hill-climbing performance.

In addition, to curb the overall energy consumption of EVs and HEVs it will be necessary to raise the battery's fast charge characteristics so as to enable the electric power generated through use of electric brakes during deceleration to be recovered for rapid acceleration—in other words so as to improve the regeneration characteristics. In this regard, it is evident for example from the operation patterns in the mode 10 to 15 driving tests shown in FIG. 8, that there are not only many acceleration sections during actual driving of a car, but also many deceleration sections, and this is why the question of how electrical energy can be recovered in the deceleration sections is relevant for curbing the overall energy consumption of EVs and HEVs.

When fast discharge or fast charge is performed, a large current flows in the battery and as a result the battery's internal resistance appears as a major influence in the battery characteristics. A requirement for obtaining adequate output characteristics and input/output characteristics—especially in batteries for EVs and HEVs—is that the internal resistance should be low and constant even when the state of charge varies. The IV resistance value, which is obtained by measuring the voltage when the battery is charged or discharged for a certain duration at several different current levels and calculating the voltage's gradient relative to the current level, is taken to represent the internal resistance resulting from state of charge variation. This IV resistance value is an indicator that shows how much current can be passed through a battery.

Incidentally, it was mentioned above that as the positive electrode active material compound for nonaqueous electrolyte secondary batteries, use is made of LiCoO₂, LiNiO₂, LiNi_{y}Co_{1-y}O₂ (y=0.01 to 0.99), LiMnO₂, LiMn₂O₄, LiCoₓMn_{y}Ni_{z}O₂ (x+y+z=1), or LiFePO₄, etc., either singly or in a mixture of two or more thereof. Among these, LiCoO₂, LiMn₂O₄ and the like have properties that provide high electrode potential and high efficiency and therefore will yield a high-voltage and high-energy density battery with excellent output characteristics, but with inferior input/output characteristics.

Thus, in view of the foregoing positive electrode active material characteristics, Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1), which has low initial charge/discharge efficiency, is preferably used as the positive electrode active material in nonaqueous electrolyte secondary batteries used as batteries for EVs or for HEVs. The discharge curves of a nonaqueous electrolyte secondary battery using such positive electrode active material, compared with those of a nonaqueous electrolyte secondary battery using a positive electrode active material with high initial charge/discharge efficiency such as LiCoO₂ or LiMn₂O₄, have the property that in the terminal stage of discharge the internal resistance rises gradually, so that the battery's output voltage falls relatively gently.

For the negative electrode active material, graphite and other carbon materials that have high initial charge/discharge efficiency are generally used. But when such carbon materials are used for the negative electrode active material and the above-described Li₁₊ₐNiₓCo_{y}M_{z}O₂ with low initial charge/discharge efficiency is used for the positive electrode active material, the negative electrode's irreversible capacity relative to the positive electrode's irreversible capacity will be small, so that unless the ratio of the negative electrode active material mass to the positive electrode active material mass is made large, there will be the problem that, since it is those regions of the positive electrode where the internal resistance is high that are used during the terminal stage of discharge, the IV resistance will be high at low states of charge. And even if such problem of high IV resistance at low states of charge is alleviated by making the negative electrode active material mass/positive electrode active material mass ratio large, there will be the problem that the output characteristics will decline because the negative electrode active material compound layer will be too thick.

### SUMMARY

The present inventors arrived at the invention when they discovered, as a result of many and varied investigations in order to curb the increase in the IV resistance value at low states of charge in a nonaqueous electrolyte secondary battery such as described above, that if carbon, which has initial charge/discharge efficiency of 80 to 90%, is used as the negative electrode active material, the regions of the positive electrode active material that have high internal resistance in the terminal stage of charging need not be used, and consequently, a nonaqueous electrolyte secondary battery can be obtained that possesses characteristics optimal for a battery for EVs or HEVs, since it will be able to maintain the IV resistance value at a constant low level, from low states of charge up to high states of charge, even if charged/discharged at large current of 50 A or higher.

JP-A-2003-142075 discloses the invention of a nonaqueous electrolyte secondary battery in which the negative electrode compound layer contains graphite and non-graphitizable (amorphous) carbon, while the positive electrode compound layer contains at least one active material selected from a group constituted of (a) an active material constituted of LiMn₂O₄ and LiNiO₂, (b) an active material constituted of LiMnₓNi₁₋ₓO₂, (c) an active material constituted of LiMn₂O₄, LiNiO₂ and LiCoO₂, and (d) an active material constituted of LiMn_{y}Ni_{z}Co_{1-y-z}O₂. In this invention, the addition of non-graphitizable carbon to the graphite that is the negative electrode active material renders the negative electrode's irreversible capacity large, so that it exceeds the positive electrode's irreversible capacity, and as a result, the generation and elution of Mn²⁺ at low states of charge are curbed. Nevertheless, from the fact that the structure is such that the current is led out from a part of the substrate via a lead body, it is evident that the nonaqueous electrolyte secondary battery disclosed in JP-A-2003-142075 cannot be used for applications requiring large current of several tens of amperes, such as for EVs or HEVs. Moreover, JP-A-2003-142075 contains no hint of a reference to performing charge/discharge at large currents of several tens of amperes, or to the increase in the IV resistance value at low states of discharge.

JP-A-2003-31262 discloses the invention of a nonaqueous electrolyte secondary battery which is high-capacity and has superior cycling characteristics, and in which the positive electrode uses a lithium-manganese-nickel composite oxide expressed by the composition formula LiₐMn_{b}Ni_{c}M_{d}O₂ (where M is at least one element selected from a group constituted of Co, Al and Fe, and 1≦a≦1.1, 0.3≦b≦0.5, 0.3≦c≦0.5, 0≦d≦0.3, b+c+d=1) as the positive electrode active material, and the negative electrode uses as the negative electrode active material a mixture composed of graphitized mesocarbon microbeads plus duplex structure graphite particles constituted of a graphite particle surface which has surface separation (d₀₀₂) at plane (002) of less than 0.34 nm (3.4 Å) as determined via wide-angle X-ray diffraction and is coated with a noncrystalline carbon layer with surface separation of 0.34 nm (3.4 Å) or higher. However, JP-A-2003-31262 contains no hint of a reference to performing charge/discharge at large currents of several tens of amperes, or to the increase in the IV resistance value at low states of discharge.

JP-A-2004-134245 discloses the invention of a nonaqueous electrolyte secondary battery which uses a mixture of a spinel-structure lithium-manganese composite oxide expressed by the composition formula Li_{1+z}Mn₂O₄ (satisfying the condition 0≦z≦0.2) and a lithium transition metal composite oxide expressed by the composition formula LiNi_{1-x-y}CoₓMn_{y}O₂ (satisfying the condition 0.5<x+y<1.0, 0.1<y<0.6) as the positive electrode active material, and moreover, as the negative electrode active material uses graphite coated with low-crystalline carbon, wherein the whole or part of the surface of a first graphite material constituting the substrate is coated with a second graphite material that is less crystalline than the first graphite material. With this invention, decline of the characteristics after charge/discharge cycling is curbed, thanks especially to the use of a negative electrode active material whose strength ratio (IA/IB), that is, ratio of 1350 cm⁻¹ strength (IA) to 1580 cm⁻¹ strength (IB) as measured by argon laser Raman spectroscopy, is in the range 0.2 to 0.3. Nevertheless, JP-A-2004-134245 contains no hint of a reference to the increase in the IV resistance value at low states of discharge.

An advantage of some aspects of the present invention is to provide a nonaqueous electrolyte secondary battery that curbs variation of the IV resistance value in the low state of charge range when charge/discharge is performed at large current of 50 A or higher not envisaged in the nonaqueous electrolyte secondary batteries of the related art, and that therefore has superior load characteristics and input/output characteristics and is optimal for EVs, HEVs and the like.

According to an aspect of the invention, a nonaqueous electrolyte secondary battery includes a positive electrode that uses as positive electrode active material a lithium transition metal compound expressed by Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1) into/from which lithium ions are insertable/separable, and a negative electrode having initial charge/discharge efficiency of 80% or over but no more than 90%; and hence has the feature of being chargeable/dischargeable at large current of 50 A or higher.

In the invention, a substance with low initial charge/discharge efficiency, such as a lithium transition metal compound expressed by Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1) into/from which lithium ions are insertable/separable, is used as the positive electrode active material. The discharge curves of a nonaqueous electrolyte secondary battery of the invention, which uses such positive electrode active material, have the property—contrasting with nonaqueous electrolyte secondary batteries using a positive electrode active material with high initial charge/discharge efficiency such as LiCoO₂ or LiMn₂O₄— that in the terminal stage of discharge the internal resistance increases gradually, so that the battery's output voltage falls relatively gently.

Also, the invention uses a negative electrode active material that yields an initial charge/discharge efficiency of 80% or over but no more than 90% for the negative electrode. With the low initial charge/discharge efficiency Li₁₊ₐNiₓCo_{y}M_{z}O₂ used for the positive electrode active material, the negative electrode's irreversible capacity relative to the positive electrode's irreversible capacity is small, so that using a negative electrode with initial charge/discharge efficiency exceeding 90% would mean that during the terminal stage of discharge the IV resistance would be high at low states of charge, since the regions of the positive electrode where the internal resistance is high would be used in such stage, and therefore it would be necessary to make the negative electrode active material mass/positive electrode active material mass ratio large. Employing such a structure would cause the output characteristics to decline because the negative electrode active material compound layer would be too thick. Also, using a negative electrode with initial charge/discharge efficiency less than 80% would result in the battery capacity falling because the negative electrode's irreversible capacity would be too large.

By contrast, when a negative electrode active material that yields negative electrode initial charge/discharge efficiency of 80% or over but no more than 90% is used, as in the nonaqueous electrolyte secondary battery of the invention, the negative electrode's irreversible capacity will be appropriately large, which means that the battery capacity will not be too small, and moreover, the positive electrode's high resistance regions will not be used during the terminal phase of discharge and the negative electrode's coating can be designed to be thin, so that a nonaqueous electrolyte secondary battery will be obtained that has a low IV resistance value even at low states of charge. Also, with the nonaqueous electrolyte secondary battery of the invention the IV resistance can be restrained from becoming high at low states of charge without the need to make the negative electrode active material mass/positive electrode active material mass ratio large.

Also, the nonaqueous electrolyte secondary battery of the invention has a structure such that a positive electrode substrate exposed portion is formed at one end of the electrode assembly, and a negative electrode substrate exposed portion is formed at the other end, and such positive electrode substrate exposed portion and negative electrode substrate exposed portion are connected, via a collector plate attached to each, to the positive electrode terminal and negative electrode terminal respectively. More precisely, in the case of a roll-type electrode assembly, substrate exposed portions are present on the elongated positive electrode plate and negative electrode plate in their longitudinal directions, and the positive and negative electrode plates are rolled, with separators interposed, in such a manner that the positive electrode substrate exposed portion and negative electrode substrate exposed portion each constitute one end of the electrode assembly, the positive and negative electrode substrate exposed portions each having a collector plate attached thereto, by means of which they are connected to the positive electrode terminal and negative electrode terminal respectively. And in the case of a stacked-type electrode assembly, the positive electrode plates and the negative electrode plates each have a substrate exposed portion at one end thereof, and the positive and negative electrode plates are stacked alternately, with separators interposed, in such a manner that the positive electrode substrate exposed portions and negative electrode substrate exposed portions each constitute one end of the electrode assembly, the positive and negative electrode substrate exposed portions each having a collector plate attached thereto, by means of which they are connected to the positive electrode terminal and negative electrode terminal respectively.

With a battery in which such positive electrode substrate exposed portion and negative electrode substrate exposed portion are not present at the two ends of the electrode assembly, and the current is led out via a positive electrode tab and a negative electrode tab attached to the positive electrode substrate and the negative electrode substrate respectively, the area of contact between the positive electrode tab and positive electrode substrate, and between the negative electrode tab and negative electrode substrate, cannot be made large, which means that the contact resistance at these parts will be large, and therefore, if large current of several tens of amperes is passed through, heat-up will occur and the thin positive electrode substrate and/or negative electrode substrate could melt.

By contrast, the nonaqueous electrolyte secondary battery of the invention has a structure such that a positive electrode substrate exposed portion is formed at one end of the electrode assembly and a negative electrode substrate exposed portion is formed at the other end, and such positive electrode substrate exposed portion and negative electrode substrate exposed portion are connected, via a collector plate attached to each, to the positive electrode terminal and negative electrode terminal respectively. Thus, the contact resistance between the positive electrode substrate and negative electrode substrates on the one hand, and the collector plates on the other, is low, and charge/discharge at large current of 50 A or higher can be performed with ease. In addition, with the nonaqueous electrolyte secondary battery of the invention the composition of the positive electrode active material and the initial discharge efficiency of the negative electrode are restricted in the manner described earlier, with the result that even when charge/discharge is performed at large current—particularly of 50 A or higher—rising of the IV resistance value at low states of charge will be markedly curbed and the output characteristics will not decline. Hence, a nonaqueous electrolyte secondary battery is obtained that is optimal for use with EVs, HEVs and the like.

As the nonaqueous solvent (organic solvent) that is a constituent of the nonaqueous solvent electrolyte in the invention, use can be made of the carbonate, lactone, ether, ester and the like that are commonly used in nonaqueous electrolyte secondary batteries, or of two or more of these solvents mixed together. Preferably carbonate, lactone, ether, ketone, or ester will be used, more preferably carbonate.

The following may be cited as specific examples: ethylene carbonate (EC), propylene carbonate, butylene carbonate, fluoroethylene carbonate (FEC), 1,2-cyclohexyl carbonate (CHC), cyclopentanone, sulfolane, 3-methylsulfolane, 2,4-dimethylsulfolane, 3-methyl-1,3-oxazolidine-2-one, dimethyl carbonate (DMC), methylethyl carbonate (MEC), diethyl carbonate (DEC), methylpropyl carbonate, methylbutyl carbonate, ethylpropyl carbonate, ethylbutyl carbonate, dipropyl carbonate, “-butyrolactone,”-valerolactone, 1,2-dimethoxyethane, tetrahydrofuran, 2-methyltetrahydrofuran, 1,3-dioxolan, methyl acetate, ethyl acetate, 1,4-dioxane, and the like.

In order to raise the charge/discharge efficiency in the invention, a mixed solvent of chain carbonates, say EC and DMC, or MEC and DEC, will preferably be used, and more preferably an asymmetrical chain carbonate such as MEC will be used. Also, it will be possible to add a nonsaturated cyclic ester carbonate such as vinylene carbonate (VC) to the nonaqueous electrolyte.

As the solute of the nonaqueous electrolyte in the invention, use can be made of the lithium salt that is commonly used as such solute in nonaqueous electrolyte secondary batteries. Examples of such lithium salt are LiPF₆, LiBF₄, LiCF₃SO₃, LiN(CF₃SO₂)₂, LiN(C₂FrSO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and mixtures of these. LiPF₆ (lithium hexafluorophosphate) will preferably be used. The amount of the solute dissolved in the nonaqueous solvent will preferably be 0.5 to 2.0 mol/L.

As the negative electrode active material in the nonaqueous electrolyte secondary battery of the invention, a carbon material that has an R value—which is the ratio of the strength at a 1360 cm⁻¹ peak to the strength at a 1580 cm⁻¹ peak as determined by argon ion laser Raman spectroscopy—greater than 0.3 and a BET specific surface area of 3 m²/g or above but no greater than 10 m²/g, may be used.

With such mode of the nonaqueous electrolyte secondary battery of the invention, the negative electrode active material compound slurry will be easy to handle during manufacture of the negative electrode and ample input/output characteristics will be obtained, besides which, the cycling characteristics, storage characteristics and other durability aspects will be good. If the negative electrode active material had an R value of 0.3 or lower, it would be necessary to make the BET specific surface area large in order to obtain an initial charge/discharge efficiency of no more than 90% for such material, but making the BET specific surface area large would not be desirable since it would render the active material compound slurry for manufacture of the negative electrode difficult to handle and would cause decline of the cycling characteristics, storage characteristics and other durability aspects. For similar reasons it would not be desirable for the BET specific surface area to exceed 10 m²/g, even with the R value being greater than 0.3. Neither would it be desirable for the BET specific surface area to be less than 3 m²/g, as then the negative electrode's reactive area would be too small and consequently it would not be possible to obtain adequate input/output characteristics.

Alternatively, the negative electrode active material in the nonaqueous electrolyte secondary battery of the invention may be a mixture of graphite with surface separation d₀₀₂ of less than 3.37 Å and carbon with d₀₀₂ of 3.37 Å or higher, as determined via wide-angle X-ray diffraction.

Using graphite that has surface separation d₀₀₂ of less than 3.37 Å will stabilize the negative electrode's charge/discharge potential curves at low potentials. Consequently, with such mode of the nonaqueous electrolyte secondary battery of the invention, the voltage at state of charge 50% will be of an appropriate level, and moreover there will be superior balance of the output characteristics and input/output characteristics across a relatively broad range of states of charge, because the charge/discharge curves will be stabilized. Further, by mixing in carbon that has d₀₀₂ of 3.37 Å or higher, the negative electrode's initial charge/discharge efficiency can be lowered even though the BET specific surface area is small, so that the nonaqueous electrolyte secondary battery will maintain high output characteristics at low states of charge and moreover will have superior durability.

Alternatively again, the negative electrode active material in the nonaqueous electrolyte secondary battery of the invention may be constituted of graphite with surface separation d₀₀₂ of less than 3.37 Å, as determined via wide-angle X-ray diffraction, which has had its surface coated with a carbon precursor and has then been fired in an inert atmosphere at 800 to 1200° C. Pitch may be used as such carbon precursor.

With such mode of the nonaqueous electrolyte secondary battery of the invention, it is possible, by firing the carbon precursor in an inert atmosphere at 800 to 1200° C., to fabricate graphite whose surface is coated with low-crystalline carbon that has d₀₀₂ of 3.37 Å or higher, so that the nonaqueous electrolyte secondary battery will have superior balance between output characteristics and input/output characteristics across a broad range of states of charge, and moreover will have superior durability. With a firing temperature less than 800° C., the functional groups in the carbon precursor's surface would not be fully removed, which would cause problems for production of the negative electrode active material compound slurry; and with a firing temperature over 1200° C., the initial charge/discharge efficiency reduction effect would not be adequate.

As a further alternative, the negative electrode active material in the nonaqueous electrolyte secondary battery of the invention may be a mixture of graphite with surface separation d₀₀₂ of less than 3.37 Å, as determined via wide-angle X-ray diffraction, which has had its surface coated with a carbon precursor and has then been fired in an inert atmosphere at 800 to 1200° C., plus carbon with surface separation d₀₀₂ of 3.37 Å or higher.

With such mode of the nonaqueous electrolyte secondary battery of the invention, a nonaqueous electrolyte secondary battery will be obtained that has superior balance between output characteristics and input/output characteristics across a broad range of states of charge, and moreover has superior durability.

Also, the positive electrode active material in the nonaqueous electrolyte secondary battery of the invention will preferably be Li₁₊ₐNiₓCo_{y}Mn_{z}O₂ (where 0≦a≦0.15, 0.25≦x≦0.45, 0.25≦y≦0.45, 0.25≦z≦0.35, a+x+y+z=1).

With such mode of the nonaqueous electrolyte secondary battery of the invention, the use of L₁₊ₐNiₓCo_{y}Mn_{z}O₂ (where 0≦a≦0.15, 0.25≦x≦0.45, 0.25≦y≦0.45, 0.25≦z≦0.35, a+x+y+z=1) as the positive electrode active material will cause the advantages of the invention to be saliently manifested, and the battery characteristics to be exceedingly fine.

### BRIEF DESCRIPTION OF THE DRAWINGS

The invention will be described with reference to the accompanying drawings, wherein like numerals reference like elements.

FIG. 1 is a graph showing the relation between states of charge and the IV resistance values measured at current levels ranging from 10 A to 50 A in the nonaqueous electrolyte secondary batteries of the first embodiment, second embodiment and comparative example.

FIG. 2 shows the relation between states of charge and the IV resistance values measured at current levels ranging from 5 A to 20 A in the nonaqueous electrolyte secondary batteries of the first embodiment, second embodiment and comparative example.

FIG. 3 is a perspective view of a cylindrical nonaqueous electrolyte secondary battery.

FIG. 4 is an exploded perspective view of an electrode roll in a cylindrical nonaqueous electrolyte secondary battery.

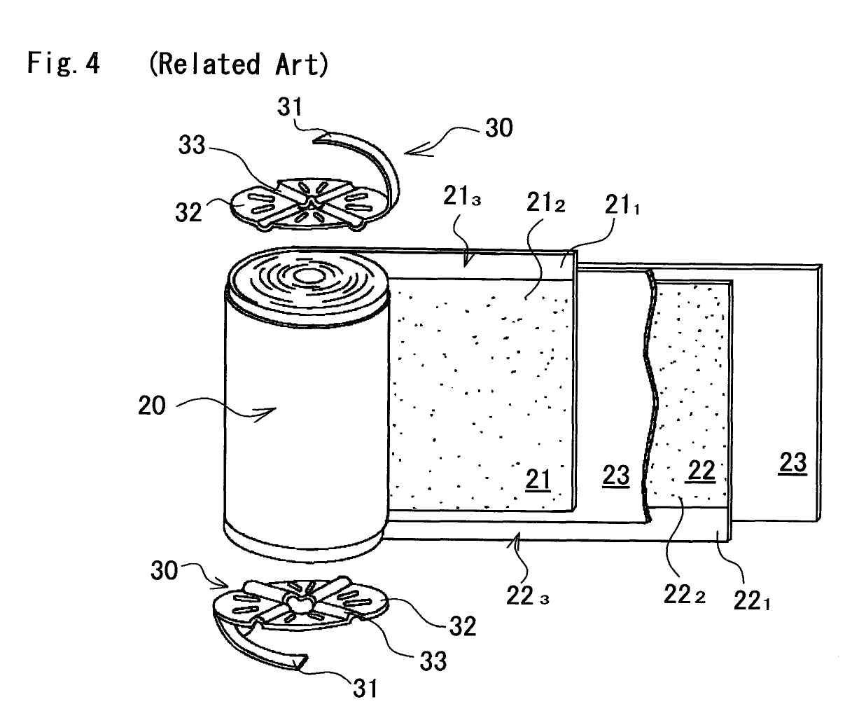

FIG. 5 is a perspective view of a collector plate used in a cylindrical nonaqueous electrolyte secondary battery.

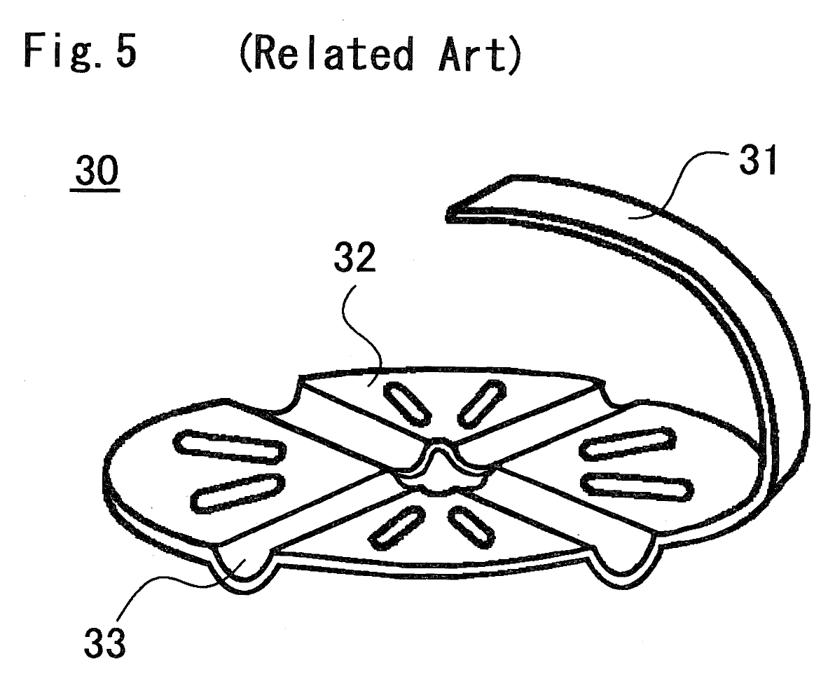

FIG. 6 is a partial perspective view showing the state before the collector plate is pushed against the electrode roll.

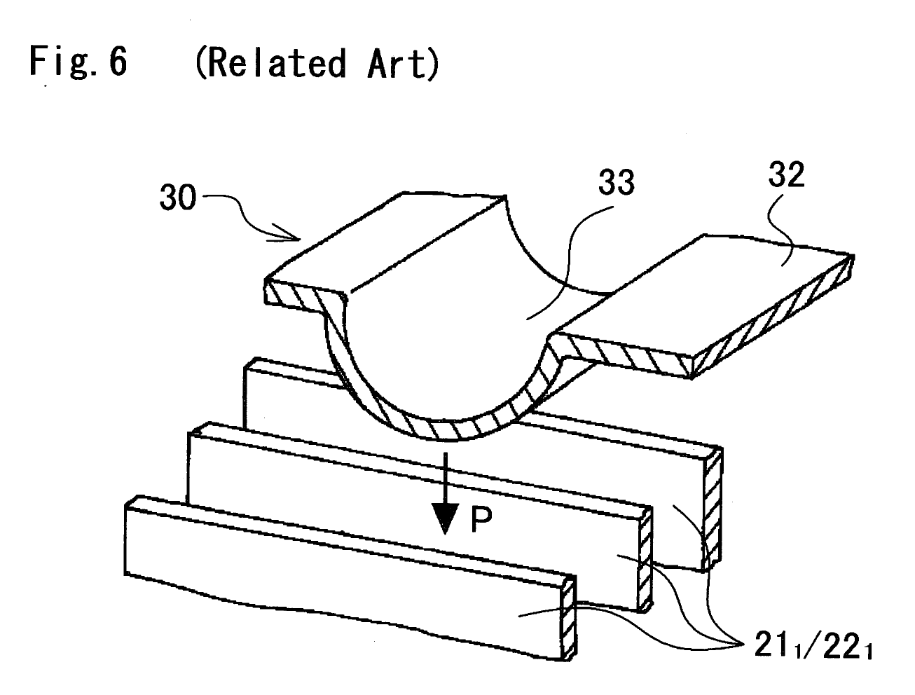

FIG. 7 is a partial front view showing the state where the collector plate is pushed against the electrode roll and irradiated with a laser beam.

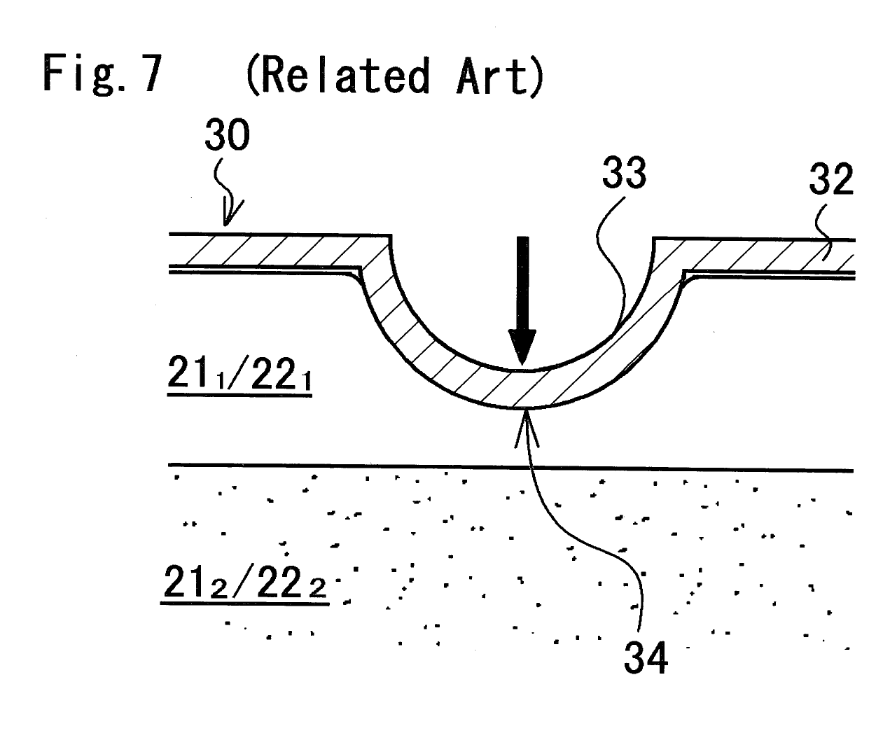

FIG. 8 is a graph showing operation patterns in driving tests using modes 10 to 15.

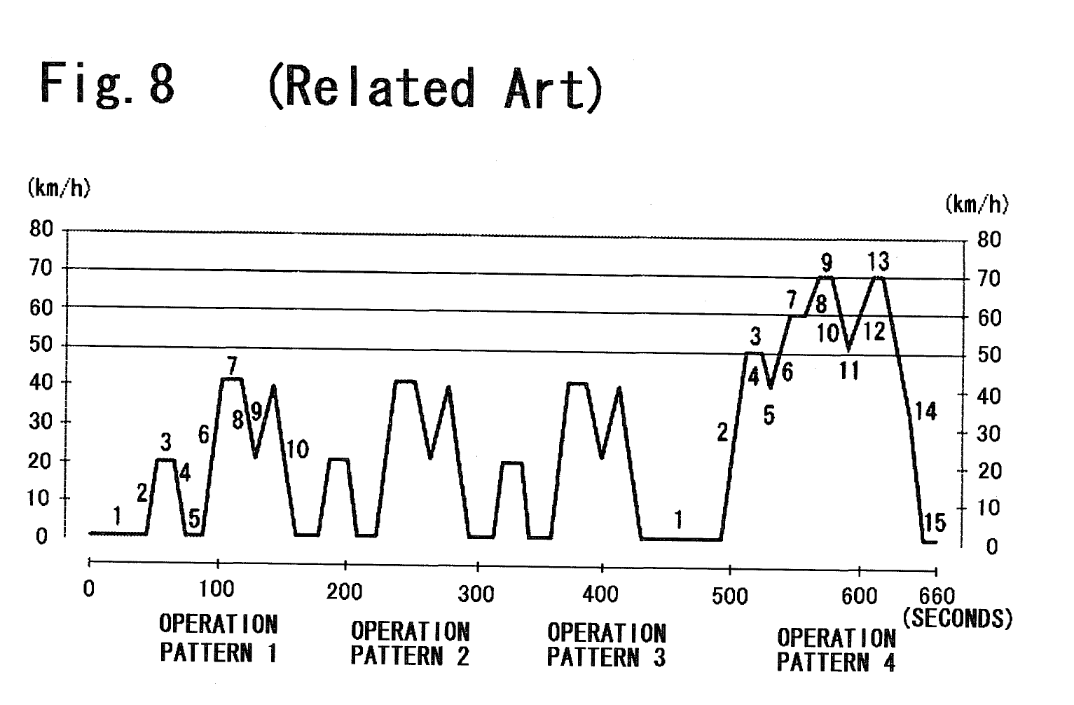

### DESCRIPTION OF EXEMPLARY EMBODIMENTS

Preferred embodiments of the invention will now be described using embodiments and a comparative example. It should be understood however that the embodiments below are intended by way of examples of nonaqueous electrolyte secondary batteries that carry out the technical concepts of the invention, not by way of limiting the invention to these particular nonaqueous electrolyte secondary batteries. The invention can equally well be applied in numerous other variants without departing from the scope and spirit of the technical concepts set forth in the claims.

### First Embodiment, Second Embodiment and Comparative Example

First, the negative electrode plate manufacturing methods for the first embodiment, for the second embodiment and for the comparative example will be described in turn. Following that, the concrete manufacturing methods, IV resistance measurement method and so forth that are common to the first and second embodiments and the comparative example will be described.

### Fabrication of Negative Electrode Plate

The negative electrode active material for the first embodiment was fabricated as follows. Natural graphite with surface separation d₀₀₂ of 3.36 Å as determined via wide-angle X-ray diffraction was mechanically processed into a spheroid particle powder, then such graphite powder was coated and impregnated with pitch in the proportion of 10% pitch to 90% graphite powder by mass, and the resulting powder was fired for 10 hours in an inert atmosphere at 1000° C. To the spheroidized low-crystalline carbon-coated natural graphite thus obtained, carbon powder with surface separation d₀₀₂ of 3.39 Å as determined via wide-angle X-ray diffraction was then added in the proportion 20% carbon powder to 80% carbon-coated natural graphite by mass, to produce the negative electrode active material. The BET specific surface area of the negative electrode active material thus obtained was 7.6 m²/g, and its R value—the ratio of the strength at a 1360 cm⁻¹ peak to the strength at a 1580 cm⁻¹ peak as determined by argon ion laser Raman spectroscopy—was 0.77.

The negative electrode active material for the second embodiment was fabricated as follows. Natural graphite with surface separation d₀₀₂ of 3.36 Å as determined via wide-angle X-ray diffraction was mechanically processed into a spheroid particle powder, then such graphite powder was coated and impregnated with pitch in the proportion of 8% pitch to 92% graphite powder by mass, and the resulting powder was fired for 10 hours in an inert atmosphere at 1000° C. To the spheroidized low-crystalline carbon-coated natural graphite thus obtained, carbon powder with surface separation d₀₀₂ of 3.39 Å as determined via wide-angle X-ray diffraction was then added in the proportion 16% carbon powder to 84% carbon-coated natural graphite by mass, to produce the negative electrode active material. The BET specific surface area of the negative electrode active material thus obtained was 6.4 m²/g, and its R value—the ratio of the strength at a 1360 cm⁻¹ peak to the strength at a 1580 cm⁻¹ peak as determined by argon ion laser Raman spectroscopy—was 0.68.

The negative electrode active material for the comparative example was fabricated as follows. Natural graphite with surface separation d₀₀₂ of 3.36 Å as determined via wide-angle X-ray diffraction was mechanically processed into a spheroid particle powder, then such graphite powder was coated and impregnated with pitch in the proportion of 1% pitch to 99% graphite powder by mass, and the resulting powder was fired for 10 hours in an inert atmosphere at 1000° C., to produce the negative electrode active material. The BET specific surface area of the negative electrode active material thus obtained was 6.2 m²/g, and its R value—the ratio of the strength at a 1360 cm⁻¹ peak to the strength at a 1580 cm⁻¹ peak as determined by argon ion laser Raman spectroscopy—was 0.26.

The physical properties of the negative electrodes manufactured in the foregoing manners for the first embodiment, the second embodiment and the comparative example are collated in Table 1 below.

TABLE 1

| | | | | BET | |
|---|---|---|---|---|---|
| | | Spheroidized | | specific | |
| | Natural | low-crystalline | | surface | |
| | graphite:pitch | carbon-coated | Carbon | area | R |
| | (ratio by mass) | natural graphite | powder | (m²/g) | value |
| First | 90:10 | 80% by mass | 20% by | 7.6 | 0.77 |
| Embodiment | | | mass | | |
| Second | 92:8 | 84% by mass | 16% by | 6.4 | 0.68 |
| Embodiment | | | mass | | |
| Comparative | 99:1 | 100% by mass | — | 6.2 | 0.26 |
| Example | | | | | |

Natural graphite: d₀₀₂ = 3.36 Å
Carbon powder: d₀₀₂ = 3.39 Å

Each of the negative electrode active materials obtained in the manners described above for the first embodiment, the second embodiment and the comparative example was blended with carboxymethyl cellulose (CMC) and styrene-butadiene rubber latex (SBR), serving as bonding agents, in the proportion 98:1:1, to make the negative electrode active material slurry. The negative electrode active material slurry thus prepared was then spread over copper foil serving as the negative electrode substrate and allowed to dry, so as to form the negative electrode active material compound layer. After that, the substrate, together with such layer, was rolled with a pressure roller to a particular packing density, to produce the negative electrode plate for the first embodiment, second embodiment or comparative example.

### Fabrication of Positive Electrode Plate

Li₂CO₃ and (Ni_{0.35}Co_{0.35}Mn_{0.3})O₄ were mixed so that the mole ratio of the Li to the (Ni_{0.35}Co_{0.35}Mn_{0.3}) was 1:1. Then such mixture was fired for 20 hours at 900° C. in an air atmosphere to obtain a lithium transition metal oxide having average particle size of 11.4″ m and expressed by LiNi_{0.35}Co_{0.35}Mn_{0.3}O₂, which would serve as the positive electrode active material. The positive electrode active material thus obtained was added, together with carbon serving as conducting agent and polyvinylidene fluoride (PVdF) serving as bonding agent, to NMP, and these substances were blended together in the proportion 88:9:3, to produce a positive electrode active material compound slurry. The positive electrode active material compound slurry thus prepared was then coated over aluminum foil serving as the positive electrode substrate and allowed to dry, so as to form the positive electrode active material compound layer. After that, the substrate, together with such layer, was rolled with a pressure roller to a particular packing density, and cut to particular dimensions to produce the positive electrode plate.

### Preparation of Nonaqueous Electrolyte

To prepare the nonaqueous electrolyte, lithium hexafluorophosphate (LiPF₆) serving as solute was dissolved in the proportion of 1 mole/liter into a solvent mixture constituted of the cyclic carbonate EC and the chain carbonate EMC mixed in the proportion of 3:7 by volume. The nonaqueous electrolyte was then produced by adding just 1% by mass of vinylene carbonate (VC) to the solution thus obtained.

### Fabrication of Nonaqueous Electrolyte Secondary Battery

Next, the positive electrode plate fabricated as described above, and the negative electrode plate fabricated as described above for the first embodiment, the second embodiment or the comparative example, were laid over each other, with separators constituted of microporous polyethylene film interposed therebetween, and were rolled into a spiral so as to make a spiral electrode array. In the positive electrode plate and in the negative electrode plate there was formed an uncoated portion constituting a substratum edge portion that projected beyond the edge of the spiral electrode array's separators. A collector plate was attached by laser welding to each of such two edges of the spiral electrode array, which was then inserted into the metallic outer can. Then the tips of the lead parts installed projecting from the edge of the collector plates were connected to the electrode terminal mechanisms.

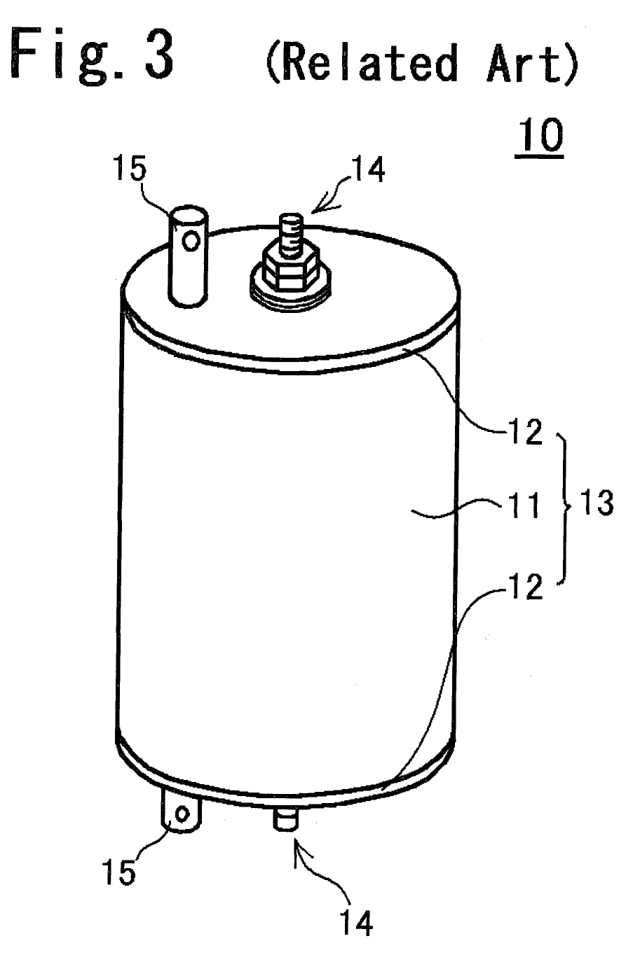

Next, the nonaqueous electrolyte prepared as described above was poured into the metallic outer can. Following that, sealing was carried out, and thereby a nonaqueous electrolyte secondary battery similar in form to that of the related art shown in FIG. 3 was produced. Further, the nonaqueous electrolyte secondary battery of the first embodiment had discharged capacity of 5.0 Ah and negative electrode initial charge/discharge efficiency of 86.2%, the nonaqueous electrolyte secondary battery of the second embodiment had discharged capacity of 5.3 Ah and negative electrode initial charge/discharge efficiency of 87.9%, and the nonaqueous electrolyte secondary battery of the comparative example had discharged capacity of 5.8 Ah and negative electrode initial charge/discharge efficiency of 92.2%. These discharged capacities and negative electrode initial charge/discharge efficiencies were measured as follows.

### Method of Measuring Discharged Capacity

The discharged capacity was measured by carrying out 4.1V constant current constant voltage charging at 1 It for two hours at room temperature of 25° C., then carrying out 3.0V constant current constant voltage discharging at ⅓ It for five hours.

### Method of Measuring Negative Electrode's Initial Charge/Discharge Efficiency

To measure the negative electrode's initial charge/discharge efficiency, at room temperature of 25° C. a piece was cut off from the battery's negative electrode plate to make an electrode with coated portion area of 12.5 cm², which was fabricated into a 3-electrode cell using lithium metal for the counter electrode and reference electrode. Such cell was then charged to 1 mV (v.s. Li/Li+) in three stages, at current levels of 0.5 mA/cm², 0.25 mA/cm² and 0.1 mA/cm², following which it was discharged to 2.0V (v.s. Li/Li+) at 0.25 mA/cm². The ratio discharged capacity/charged capacity was then calculated and taken as the initial charge/discharge efficiency.

### Method of Measuring IV Resistance

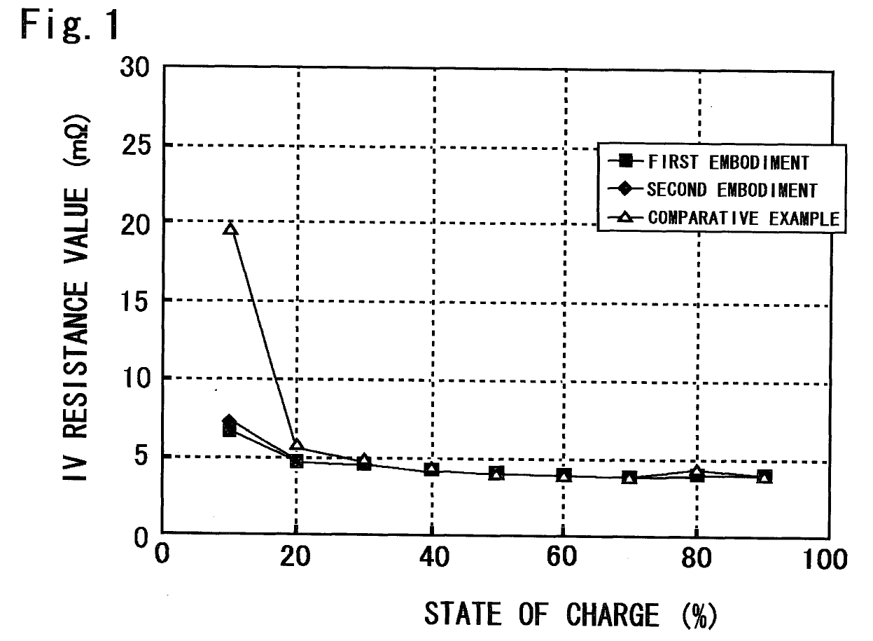

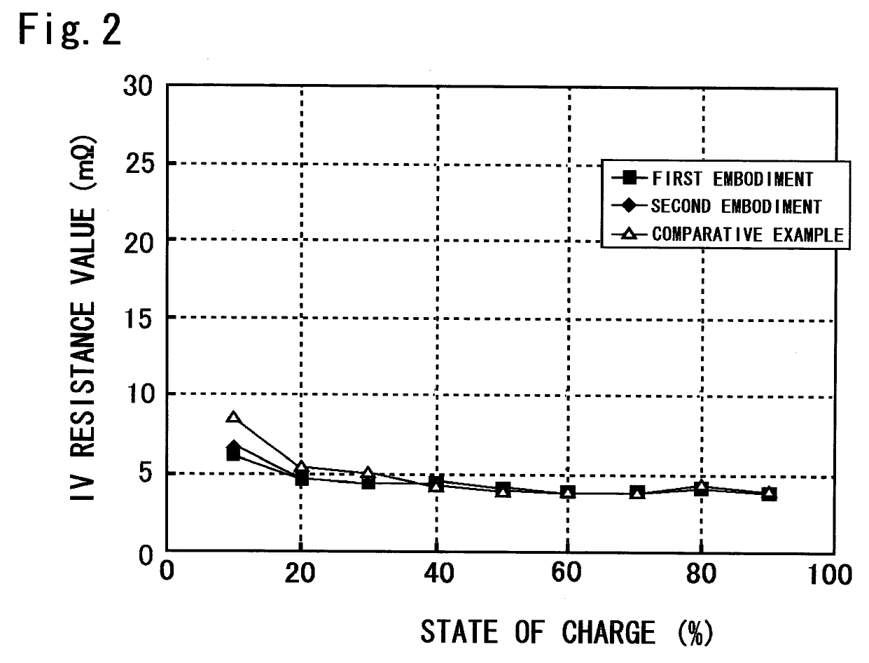

At room temperature of 25° C. the battery was charged with 5 A charging current to various states of charge, and was discharged for 10 seconds with each of the following currents: 10 A, 20 A, 30 A, 40 A and 50 A. The battery voltage at each such discharge was measured, and the various current levels and battery voltages were plotted so as to find the I-V characteristics during discharge. Then the IV resistance (me) during discharge was derived from the gradient of the straight line obtained. In this way, the IV resistance value at particular states of charge was determined. States of charge that were altered by the discharging were restored to their original levels by charging with 5 A constant current. The relation between the states of charge and the values measured for IV resistance is shown in FIG. 1. Also, FIG. 2 shows the relation between the states of charge and the values measured for IV resistance at current levels of 5 A, 10 A, 15 A, and 20 A.

The following facts can be deduced from the results shown in FIGS. 1 and 2. The batteries of the first and second embodiments have essentially the same IV resistance value, whether it is measured over the 5 to 20 A range or over the 10 to 50 A range, and in the 30 to 90% state of charge range it is a low IV resistance value of no more than 5 mΩ. Also, at state of charge 10%, the IV resistance values measured in the 10 to 50 A range (FIG. 1) were slightly higher than those measured in the 5 to 20 A range (FIG. 2).

By contrast, the battery of the comparative example, although having a low IV resistance value—whether measured in the 5 to 20 A range or in the 10 to 50 A range—of no more than 5 mΩ in the 20 to 90% state of charge range, essentially the same as the batteries of the first and second embodiments, has a higher IV resistance value than the batteries of the first and second embodiments when the state of charge is no more than 20%. Particularly at state of charge 10%, the comparative example battery's IV resistance measured in the 5 to 20 A range was a large value, being around 1.5 times the IV resistance value of the first and second embodiment batteries, and when measured in the 10 to 50 A range, the comparative example battery's IV resistance value rose to around 2.7 times that of the first and second embodiment batteries. To enable charge/discharge at large current of 50 A and higher, the 25° C. IV resistance value measured in the 10 to 50 A range at stage of charge 10 to 90% will, in consideration of the battery's resistance heat-up and input/output characteristics, preferably be no more than 15 ma, whereas the comparative example battery's IV resistance value exceeds 15 mΩ at state of charge 10%.

Thus, compared with the nonaqueous electrolyte secondary battery of the comparative example, the first and second embodiment batteries, fabricated according to the invention, maintain a constantly low IV resistance value across a wide range of states of charge, even when charged/discharged at large current or 50 A or higher, from which it will be appreciated that they are optimal as batteries for EVs or HEVs, which are required to have particularly ample output characteristics and input/output characteristics.

As has been described above, when a lithium transition metal compound expressed by Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1), which has low initial charge/discharge efficiency and into/from which lithium ions are insertable/separable, is used as the positive electrode active material, combined with use of a negative electrode having initial charge/discharge efficiency of 80% or over but no more than 90%, the irreversible capacity of the negative electrode will be large, so that the positive electrode's high resistance regions will not be used during the terminal phase of discharge and moreover the negative electrode's coating can be designed to be thin, with the result that, without any particular need to make the negative electrode active material mass/positive electrode active material mass ratio large, a nonaqueous electrolyte secondary battery can be obtained that has a low IV resistance value even at low states of charge.

What is claimed is:

1. A nonaqueous electrolyte secondary battery comprising:
a positive electrode that uses as positive electrode active material a lithium transition metal compound expressed by Li₁₊ₐNiₓCo_{y}M_{z}O₂ (where M is at least one element selected from among Mn, Al, Ti, Zr, Nb, B, Mg, Mo, and 0≦a≦0.3, 0.1≦x≦1, 0≦y≦0.5, 0≦z≦0.9, a+x+y+z=1) into/from which lithium ions are insertable/separable;
and a negative electrode that has initial charge/discharge efficiency of 80% or over but no more than 90%;
the battery being capable of being charged or discharged at large current of 50 A or higher.

2. The nonaqueous electrolyte secondary battery according to claim 1, wherein a carbon material that has an R value—which is the ratio of the strength at a 1360 cm⁻¹ peak to the strength at a 1580 cm⁻¹ peak in argon ion laser Raman spectroscopy—greater than 0.3 and a BET specific surface area of 3 m²/g or above but no greater than 10 m²/g is used as the negative electrode active material.

3. The nonaqueous electrolyte secondary battery according to claim 2, wherein the negative electrode active material is a mixture of graphite having surface separation d₀₀₂ of less than 3.37 Å and carbon having d₀₀₂ of 3.37 Å or higher, as determined via wide-angle X-ray diffraction.

4. The nonaqueous electrolyte secondary battery according to claim 2, wherein the negative electrode active material is graphite with surface separation d₀₀₂ of less than 3.37 Å, as determined via wide-angle X-ray diffraction, which has had its surface coated with a carbon precursor and has then been fired in an inert atmosphere at 800 to 1200° C.

5. The nonaqueous electrolyte secondary battery according to claim 4, wherein the carbon precursor is pitch.

6. The nonaqueous electrolyte secondary battery according to claim 2, wherein the negative electrode active material is a mixture of graphite with surface separation d₀₀₂ of less than 3.37 Å, as determined via wide-angle X-ray diffraction, which has had its surface coated with a carbon precursor and has then been fired in an inert atmosphere at 800 to 1200° C., plus carbon with surface separation d₀₀₂ of 3.37 Å or higher.

7. The nonaqueous electrolyte secondary battery according to claim 1, wherein the positive electrode active material is Li₁₊ₐNiₓCo_{y}Mn_{z}O₂ (where 0≦a≦0.15, 0.25≦x≦0.45, 0.25≦y≦0.45, 0.25≦z≦0.35, a+x+y+z=1).
